(19) United States
(12) Patent Application Publication
(10) Pub. No.: US 2002/0092834 A1
(43) Pub. Date: Jul. 18, 2002

(54) Apparatus for coating a substrate with a plasma arc torch

(75) Inventors: Steffen Nowotny, Radebeul (DE); Roman Zieris, Dresden (DE); Tobias Neumann, Dresden (DE); Gerhard Eckart, Dresden (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Fraunhofer-Gesellschaft Zur Forderung der angewandten Forschung e.V., Munchen (DE)

(21) Appl. No.: 10/027,684

(22) Filed: Dec. 20, 2001

(30) Foreign Application Priority Data
Dec. 21, 2000 (DE) 100 65 629.3

(51) Int. Cl. B23K 10/00; B23K 26/14

(52) U.S. Cl. 219/121.47; 219/121.52; 219/76.16

(57) ABSTRACT

The invention relates to an apparatus for coating a substrate with a plasma arc torch, and with such a plasma arc torch the powdery additive is to be heated, melted open and accelerated towards the surface with plasma gas generated in the plasma arc torch, and with an additional laser beam. In the plasma arc torch, an annular cathode is located or a plurality of individual cathodes are arranged about a longitudinal axis. Gas is supplied into a plasma space which is located between such an annular cathode or the plurality of cathodes, and such an annular anode. With the invention, coating is to be allowed to be formed with a higher speed and deposition rate, respectively, with respect to the conventional solution with the same and increased quality, respectively, and the directional independence for the formation of the coating is to be ensured. This object is substantially solved in that the laser beam is directed upon the surface to be coated through such an annular cathode or between a plurality of cathodes arranged about the longitudinal axis, and through the annular shaped anode coaxially with respect to the longitudinal axis A.

The invention relates to an apparatus for coating a substrate with a plasma arc torch according to the preamble of claim 1.

It is well known to provide the most different substrates with a surface coating wherein a powdery additive can be used. Then, an arc can be started between a cathode and a cathode array, respectively, and preferably an annular anode, and a plasma is generated with a supplied gas which is melting open the powdery additive supplied into the plasma and the appropriately accelerated plasma gas, respectively, and which is accelerated towards the surface of the substrate which is to be coated. After impacting and cooling the desired coating is allowed to be formed then on the surface.

An appropriate plasma arc torch in which a cathode array consisting of several pin shaped members arranged about a center line, for example, is described in DE 41 05 407 A1. Then, an annular anode is arranged at the exit of the plasma arc torch, and the heated powdery additive, e.g. metal or ceramic powder is supplied through the annular aperture centrally between the individual pin shaped cathodes into the plasma space in which the plasma is formed with a plasma gas being supplied from the outside of the cathode array by means of a carrier gas flow.

The necessary energy is exclusively provided through the arc required for the plasma formation and the kinetic energy of the plasma and/or carrier gas for the powdery additive.

Furthermore, the so called laser plasma hybrid spraying techniques and appropriate devices are well known in which additional energy is supplied with a laser beam. An appropriate method is described in DE 197 40 205 A1, for example. However, generally with this hybrid technique the laser beam is directed externally within a more or less obliquely inclined angle with respect to the longitudinal axis of the plasma beam upon the surface of a substrate to be coated wherein the size of the focal spot on the surface can be adjusted more or less great manner according to the desired intensity. The energy supplied with the laser beam is not allowed only to be used for the formation of the molten mass of the additive impacting on the surface, however, it can also be used for preheating possibly required for the substrate surface and/or for influencing the temperature regime during solidifying of the molten mass for a selective formation of specific structures and micro type structures.

However, with the hybrid techniques it is disadvantageous that the appropriate apparatus consisting of the plasma arc torch and laser elements has to be formed either stationarily, and for the formation of the coating upon substrates these substrates have to be moved appropriately, or the laser and plasma beams have to be moved synchronously with the respective elements in a lavish manner wherein in this case the motion cannot readily be provided continuously in any directions, i.e. in the x- and y-axes.

Therefore, it is an object of the invention to propose an apparatus in which the coating can be formed with a higher speed and deposition rate, respectively, with respect to conventional solutions of the same and increased quality, respectively, and wherein coating is allowed to be formed in a unidirectional manner.

According to the invention this object is achieved with an apparatus comprising the features of claim 1. Advantageous aspects and improvements of the invention can be obtained with the features mentioned in the subclaims.

The apparatus according to the invention is using the elements for a plasma arc torch known from the prior art wherein the powdery additive can be heated, melted open and accelerated towards the surface of the substrate to be coated.

For this, the substantial elements are a cathode or an array of several individual cathodes, and an annular anode being spaced thereto, wherein between them a plasma can be generated by means of an arc of supplied plasma gas.

Then, the cathode is to be designed either as an annular cathode or an array of several cathodes which are arranged about a longitudinal axis A, and the laser beam and annular anode are directed upon the substrate surface through the annular cathode or between the individual cathodes of the cathode array through the generated plasma, wherein the laser beam is aligned coaxially with respect to the longitudinal axis A.

With a cathode array provided with a plurality of individual cathodes these individual cathodes are preferably located symmetrically about the longitudinal axis A, i.e. at possibly equal angular distances from each other, and at equal distances with respect to the longitudinal axis A.

The plasma gas is supplied into a plasma space to form the plasma and for accelerating the powdery additive towards the substrate surface with increased speed with respect to known solutions, wherein the supplied powdery additive will not only be accelerated towards the substrate surface but will already be heated by means of the plasma energy. The energy of the plasma beam is in addition thereto and serves for the formation and maintaining of a molten bath consisting of additive on the substrate surface such that the laser energy can additionally heat the already heated additive as a second form of energy such that the coating efficiency can be increased in particular by shortening the coating time period.

Then, with a constant laser capacity and laser intensity in the focal spot it is readily allowed to work on the substrate surface.

The center line of the laser beam should be aligned in parallel with the longitudinal axis A which is substantially predetermined through the cathode, cathode array and the annular anode. Preferably, the longitudinal axis and center line of the laser beam should be identical.

For generating the laser beam the solid state lasers or diode injection lasers in particular are suitable for a laser light source. However, carbon dioxide lasers can also be used.

Such laser light sources radiate the laser light in a wavelength range which is only absorbed slightly by the plasma and plasma gas, respectively. Therefrom, it results that the laser energy is allowed to be mainly absorbed by the supplied powdery additive, and accordingly to be utilized in an effective manner.

Generally, the laser light sources and plasma gas should be selected such that the respective wavelength of the laser light will not be absorbed by the plasma or only in a limited manner.

The plasma gas can be a pure gas, e.g. helium, however, a gas mixture, e.g. a gas mixture containing Helium.

The laser beam can be directed via the appropriate optical elements directly through an annular cathode or through an appropriate array of several individual cathodes, the plasma space and the annular anode upon the surface of the substrate.

However, there is also a way to guide one laser beam at least via one optical fibre or a plurality of laser beams into the apparatus wherein a focussing element is to be arranged at the exit of the optical fibre(s).

Such a focussing element or appropriately designed laser optic are allowed to be adjusted or selected such that the focus of the laser beam is formed in the area of the annular cathode or cathode array, and in addition it is ensured that the laser beam expanding in the direction of the substrate is directed upon the substrate surface through the annular anode in a contactless manner. With an appropriate optic the position of the focus, and therefore the size of the focal spot can be influenced within limits.

Feeding the powdery additive into the appropriately heated and accelerated plasma gas can occur in a different form. Thus, on the one hand there is the way to arrange such feeding means for powdery additive succeeding to the annular anode such that it will be feeded between the annular anode and substrate surface into the plasma gas jet. In particular, with small exposed cross sections of such an annular anode this prevents from depositing the powdery particles already melted open on the anode wall, and thus clogging of the annular anode can be readily prevented.

However, there is also a way to design the feeding means of the powdery additive as an annular nozzle and annular aperture nozzle, respectively, and to dimension and arrange them such that it allows an external side powdery feeding about the laser optic 7 and/or the cathode and cathode array, respectively.

The selection and arrangement of the feeding means for powdery additive can be chosen under consideration of the used additive wherein on an apparatus according to the invention two appropriately arranged and designed feeding means for powdery additive can also be available which are allowed to be alternatively but commonly used as well.

The feeding means for the required plasma gas into the plasma space of an apparatus according to the invention can be performed in a manner known from the prior art, however, wherein higher flow rates (200 to 500 m/s and volume rates (40 to 80 l/min) are possible.

With respect to the known solutions such as the hybrid techniques initially mentioned this apparatus according to the invention is distinguishing in particular by means of the interaction between the additive and laser beam which does not only just occur on the substrate surface.

Advantageously, the interaction period between the powdery additive and laser beam are allowed to be increased, and the power losses are allowed to be reduced. The portion of the laser energy which is not absorbed, reflected and scattered by the powdery additive can be almost completely absorbed from the substrate surface, and therefore be used with an enhanced efficiency.

With the possibility of an orthogonal alignment of the plasma and laser beams upon the substrate surface to be coated imaging distortions of the laser beam upon the substrate surface can be avoided, and a uniform intensity in the focal spot can be maintained.

With the enhanced efficiency and more favourable interaction of the laser light and plasma having powdery additive, the deposition rate can also be enhanced several times in addition to the melting efficiency with respect to the conventional solutions such as the well known hybrid techniques.

The complete apparatus can be moved in a simple manner in the most different directions across the surface of the substrate, and then coating can be formed according to this motion. With the plasma arc torch switched off a locally selective heat treatment can be solely performed with the laser beam on the substrate surface and the coating, respectively.

In the following the invention will be described by way of example.

In the drawings

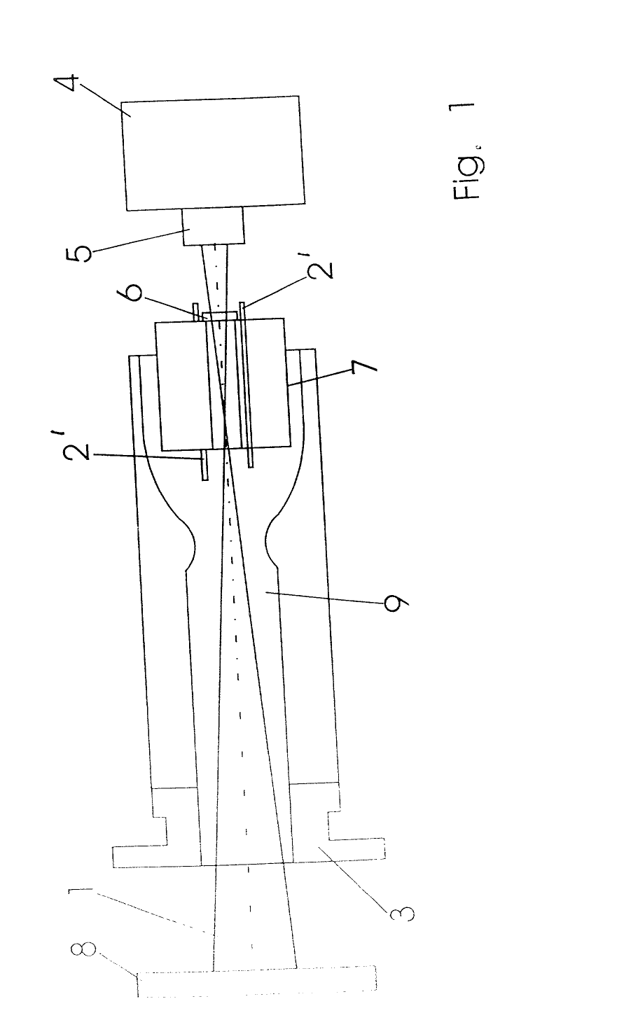

FIG. 1 shows an embodiment of an apparatus according to the invention having a cathode array formed of a plurality of individual cathodes; and

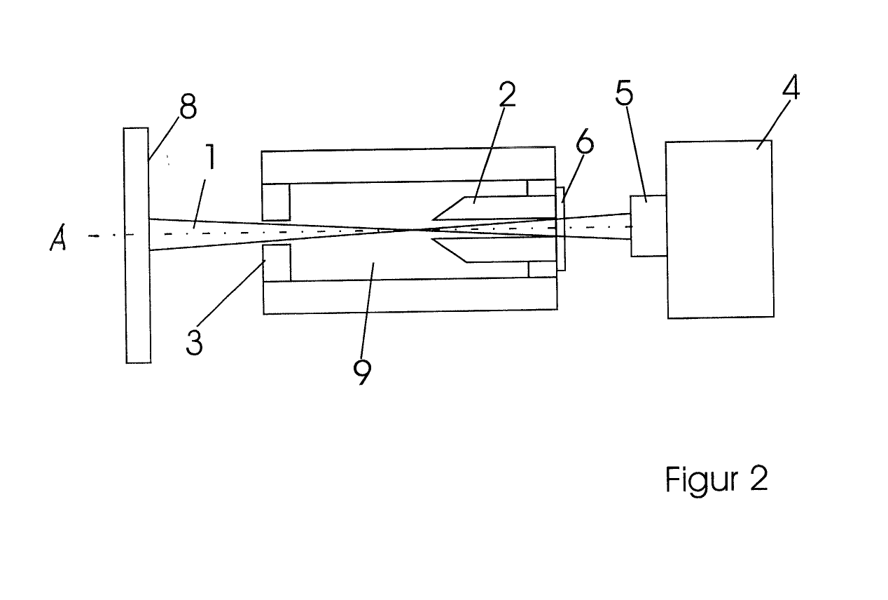

FIG. 2 shows an embodiment of an apparatus according to the invention having an annular shaped cathode.

The embodiment of an apparatus according to the invention shown in FIG. 1 originates from a plasma arc torch such as described in the substantial points in DE 41 05 407 A1. Then, a plurality of rod like individual cathodes 2′ are received in an isolator body 7, which are connected to the power supply in a manner not shown. The individual cathodes 2′ are arranged symmetrically about the longitudinal axis A.

Between the rod like cathodes 2′ within the isolator body 7 an aperture is formed through which the laser beam 1 can be guided and which is occluded to the outside with a transparent window 6 in this embodiment.

However, there is also the way for the isolator body 7 in a form not shown to be constructed in a transparent manner for the laser beam at least in its central area between the individual cathodes 2′.

The laser beam 1 is radiated from the laser light source 4 which here is a conventional solid state laser, through a focussing laser optic 5 into the actual plasma arc torch. The laser optic 5 focusses the laser beam 1 such that the focus is located between the individual cathodes 2′.

The annular anode 3 which is connected to the power supply as well is located at the exit of the plasma space 9 towards the substrate 8 to be coated. Then, the inner exposed cross section of the annular anode 3 is selected such that the laser beam 1 can be directed upon the surface of the substrate 8 in a contactless manner.

In a form not shown, the plasma gas originating from the outer edges of the isolator body 7 is allowed to flow into the plasma space 9, and thus the plasma can be generated with the arc burning between the annular anode 3 and the individual cathodes 2′. By means of the reflowing plasma gas, the plasma is allowed to be accelerated with the supplied additive towards the surface of the substrate 8 in a form not shown as well, and as previously mentioned in the introduction part to the specification it is allowed to be heated and melted open. Then, the combination of the plasma energy and energy of the laser beam 1 has a favourable effect.

For the arc formation to generate the plasma a voltage of approximately 60V and a current having a current strength of 580 A can be applied to the annular anode 3 and the individual cathodes 2′.

As a plasma gas for example, a gas mixture consisting of argon and hydrogen which are mixed in relation of 40 liters of argon and 5 liters of hydrogen per minute can be feeded into the plasma space 9.

As an additive, a self flowing metal alloy which is feeded with a mass flow rate of 30 g/min can be used.

Feeding the powdery additive is allowed to be supplied immediately into the plasma space 9 such as in the general part of the specification that is coaxially to the plasma and laser beam 1 but is also radially from the outside externally from the plasma arc torch, i.e. after the plasma gas has left the annular anode 3, wherein feeding them can be performed with the most different angles with respect to the longitudinal axis A.

The embodiment of the apparatus according to the invention shown in FIG. 2 differs from the embodiment of FIG. 1 substantially by use of a one-piece annular cathode 2 through which the laser beam 1 can be directed upon the surface of the substrate 8 to be coated.

In the two shown embodiments the center line of the laser beam 1 and the longitudinal axis A coincide.

1. An apparatus for coating a substrate with a plasma arc torch in which a powdery additive is heated, melted open and accelerated towards the surface of said substrate by means of the plasma gas generated in said plasma arc torch, and with a laser beam;
wherein in said plasma arc torch an annular cathode or a plurality of individual cathodes are arranged about a longitudinal axis (A); and
gas can be supplied into a plasma space between said cathode(s) and an annular anode, characterized in that said laser beam (1) is directed upon the surface to be coated through said annular cathode (2) or between a plurality of said cathodes (2′) arranged about the longitudinal axis (A), and said annular shaped anode (3) coaxially with respect to said longitudinal axis (A).

2. An apparatus according to claim 1, characterized in that the center line of said laser beam (1) and said longitudinal axis (A) are aligned in parallel to each other, and/or coincide in a common axis.

3. An apparatus according to claim 1 or claim 2, characterized in that a laser light source (4) for generating said laser beam (1) is a solid state laser or a diode injection laser.

4. An apparatus according to any one of the claims 1 to 3, characterized in that said laser beam (1) has a wavelength which is not absorbed by said plasma.

5. An apparatus according to any one of the claims 1 to 4, characterized in that said plasma gas is a gas or gas mixture forming a plasma which is transparent to the wavelength of said laser light.

6. An apparatus according to claim 5, characterized in that said plasma gas is helium or a gas mixture containing helium.

7. An apparatus according to any one of the claims 1 to 6, characterized in that said laser beam (1) is guided from said laser light source (4) via at least one optical fibre into said apparatus.

8. An apparatus according to any one of the claims 1 to 7, characterized in that a laser optic (5) is adjusted or selected such that the focus of said laser beam (1) is formed in the area of said cathode (s) (2, 2′).

9. An apparatus according to any one of the claims 1 to 7, characterized in that a feeding device for a powdery additive is arranged succeeding to said annular anode (3) towards said substrate (8) to be coated.

10. An apparatus according to any one of the claims 1 to 8, characterized in that a feeding device for coaxially feeding said powdery additive is formed as an annular nozzle which encloses said laser optic (5) or said cathode(s) (2, 2′).
